(19) United States
(12) Patent Application Publication
(10) Pub. No.: US 2012/0024724 A1
(43) Pub. Date: Feb. 2, 2012

(54) Medicine Disposal Container

(75) Inventors: Ian R. BEARDSALL, Telford (GB); Robert J. WHITWOOD, Telford (GB); Sandra D. EVANS, Telford (GB); Peter WATTS, Nottingham (GB); Alan Smith, Nottingham (GB)

(73) Assignee: ARCHIMEDES DEVELOPMENT LIMITED, Nottingham (GB)

(21) Appl. No.: 13/196,061

(22) Filed: Aug. 2, 2011

(30) Foreign Application Priority Data
Aug. 2, 2010 (EP) 10171648.8

(51) Int. Cl. B65D 81/00; B23P 17/00

(52) U.S. Cl. 206/205; 29/428

(57) ABSTRACT

Embodiments of the present invention provide a container for liquid medicine disposal, wherein the container has one or more interior surfaces associated with activated carbon cloth for capturing a drug dissolved in the liquid medicine. Embodiments of the present invention are particularly intended for use when dispensing a medicine spray, wherein the container must be held inverted whilst dispensing the spray.

### PRIORITY

This application claims the benefit of priority to European Patent Application No. 10171648.8, filed Aug. 2, 2010, the entire contents of which are hereby incorporated by reference herein.

### FIELD OF THE INVENTION

Embodiments of the present invention relate to a container for disposing of medicines. In particular, although not exclusively, embodiments of the invention relate to a container for capturing and disposing of liquid medicines dispensed in the form of a spray.

### BACKGROUND

The safe use of medicines applies not only to their administration to patients but also to their disposal. Safe disposal of medicines is important in order to avoid unwanted exposure to drug compounds with potentially hazardous, even fatal, effects. Although such unintended exposure could be harmful to the patient, it is of particular concern if it is to individuals who are not receiving the medication, including family members or other household contacts, and especially children, and carers and pets.

Some liquid medicines, by which we mean a liquid in which the drug substance is dissolved or suspended, are dispensed in the form of a spray, for example for administration into the oral cavity, nose, lungs, skin or eye.

Dosage forms using metered dose sprays, such as nasal sprays, present a particular disposal challenge. Referring to FIG. 1, a typical nasal spray 100 comprises a bottle 110, which holds liquid medication 120, to which is attached a metered-dose spray pump 130. The example spray 100 shown in FIG. 1 comprises a nozzle 140 for insertion into a nasal passage of a patient, although it will be realised that other nozzle configurations may be utilised. In response to actuation of the pump 130, liquid 120 is drawn into the pump 130 via a dip tube 150 which extends downward into the medication 120. In order for the pump 130 to function correctly it has to be used in a substantially upright orientation, by which we mean that the dosing nozzle 140 is at an angle which does not exceed approximately 45° from vertically upward.

Before the spray 100 is used to administer a dose, it needs to be “primed”. In the priming process the dispensing mechanism of the pump 130 is actuated to draw liquid into the dip tube 150 and the pump 130. As illustrated in FIG. 2, the pump 130 may be primed by a force 210 applied between the bottle 110 and the pump 130. Actuating the pump draws 220 liquid from the bottle 110 up the dip tube 150 and fine droplets of the liquid are expelled 230 from the nozzle 140 as a spray. A number of actuations i.e. presses of the pump 130 may be required in order to displace all of the air in the dip tube 150 and pump 130 and to replace it with liquid 120. When primed, the spray 100 dispenses a full dose of the medication 120 to the patient.

In the process of priming the spray 100, some droplets 230 comprising liquid 120 are emitted from the spray 100 into the atmosphere. If the drug compound in question is hazardous, it is desirable to capture the liquid 230 emitted from the spray 100 during priming. Similarly, if medication 120 remains in the bottle 110 at the end of use, it may need to be emptied which may require further actuations of the spray 100.

To capture the drug droplets 230 which require disposal, it is possible to use an absorbent paper material such as a tissue. However, the individual may be exposed through skin contact to the liquid 120 containing the drug when holding the paper material. Furthermore, the discarded tissue or paper itself represents a hazard, if accidentally ingested for example.

This invention aims to solve the problems associated with the safe capture and disposal of unwanted liquid medications, particularly medications administered from sprays.

It is an object of embodiments of the invention to at least mitigate one or more of the problems of the prior art.

### SUMMARY OF THE INVENTION

According to a first aspect of the invention there is provided a container for liquid medicine disposal having one or more interior surfaces associated with activated carbon for capturing a drug dissolved in the liquid medicine. The invention may also be useful for capturing drug in the form of a liquid suspension, in particular in the scenario where an attempt is made to recover the drug from the container by adding a solvent for the drug. In such a scenario, when the solvent is added, the drug will dissolve and may then adsorb to the activated carbon thus rendering it unrecoverable.

According to a second aspect of the invention there is provided a method of making a container for disposing of liquid medicine, comprising associating activated carbon with one or more interior surfaces of the container for capturing a drug within the liquid medicine.

According to a further aspect of the invention there is provided a container for liquid medicine disposal, characterised by the container having one or more interior surfaces associated with an activated carbon cloth for capturing a drug dissolved in the liquid medicine and an absorbent material for absorbing a liquid component of the medicine.

According to a further aspect of the invention there is provided a method of making a container for disposing of liquid medicine, characterised by comprising: associating an activated carbon cloth with one or more interior surfaces of a container for capturing a drug within the liquid medicine.

According to a further aspect of the invention there is provided a method of disposing of a liquid medicine, comprising placing the liquid medicine in a container having one or more interior surfaces associated with activated carbon cloth, such that the activated carbon cloth at least partly adsorbs a drug present in the medicine. Optionally, the method comprises substantially sealing the container.

### BRIEF DESCRIPTION OF THE DRAWINGS

Embodiments of the invention will now be described by way of example only, with reference to the accompanying figures, in which:

FIG. 1 shows an example of a spray for use with embodiments of the invention;

FIG. 2 illustrates the operation of the spray;

FIG. 3 shows a first embodiment of the invention;

FIG. 4 shows a second embodiment of the invention;

FIG. 5 shows three embodiments of the invention;

FIG. 6 illustrates a method of manufacturing an embodiment of the invention;

FIG. 7 illustrates an embodiment of the invention;

FIG. 8 illustrates another embodiment of the invention; and

FIG. 9 illustrates a further embodiment of the invention.

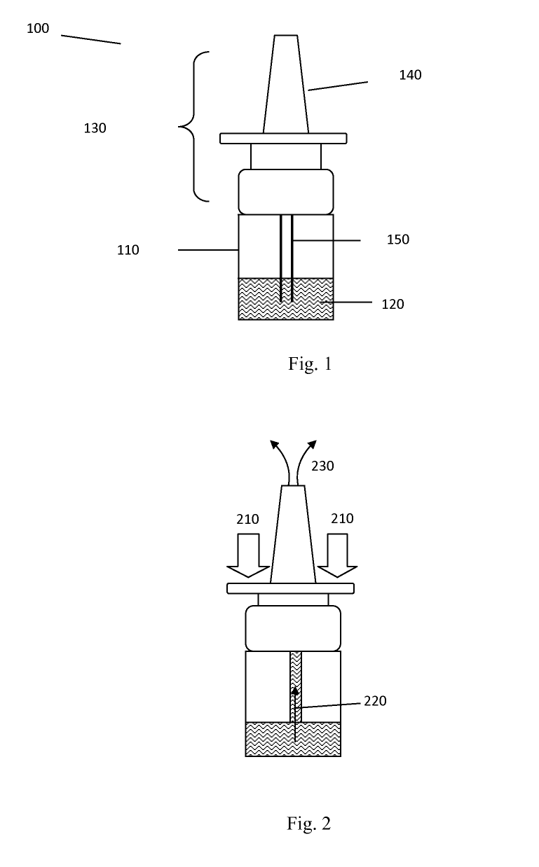

### DETAILED DESCRIPTION OF EMBODIMENTS OF THE INVENTION

Embodiments of the present invention provide a drug capture device in the form of a container having one or more interior walls which are associated with activated carbon cloth to adsorb drugs. In some embodiments, the container may further comprise a material to absorb a liquid in which the drug is dissolved or suspended.

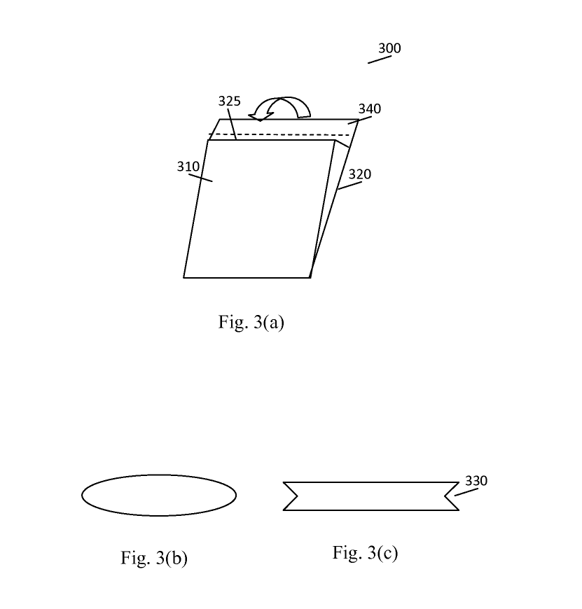

A container 300 according to a first embodiment of the invention is shown in FIG. 3. In the first embodiment of the invention, the container 300 is in the form of a pouch 300, which is illustrated particularly in FIG. 3(a).

In some embodiments, the pouch 300 comprises first 310 and second 320 substantially planar sheets forming a front and back of the pouch 300, respectively. The front and back sheets 310, 320 may be bonded together around three peripheral edges, i.e. along bottom and opposing side edges of the pouch 300. The bonding may be achieved using adhesive or by heating the sheets 310, 320. FIG. 3(b) shows a cross section through the pouch 300 when formed by affixing peripheral edges of the sheets 310, 320. Alternatively, as shown in FIG. 3(c), concertinaed side portions 330 may interpose the first and second sheets 310, 320 at opposing sides of the pouch 300 to separate and allow relative movement of the sheets 310, 320 toward and away from each other. It will be realised that other constructions of the pouch 300 may be envisaged, such as the pouch 300 being formed by a single sheet of material folded over and bonded along a side and a bottom edge.

A top edge of the pouch is left open, i.e. the sheets 310, 320 are separate to form an opening 325 into the pouch 300 to allow the nozzle 140 of the spray 100 to be inserted into the pouch 300 during priming of the pump 130.

In some embodiments, the second sheet 320 forming the back of the pouch 300 may include a flap portion 340 which extends upward beyond the upper edge of the first sheet 310. The flap portion 340 may be formed from the second sheet 320 and be divided there-from by a fold, indicated with a dotted line in FIG. 3, which encourages folding of the flap portion 340 along the upper edge of the pouch 300 over the first sheet 310 so as to substantially seal the pouch 300. An interior face of the flap portion 340, i.e. facing the first sheet 310 when folded over, may include an adhesive layer for sealing the flap portion 340 to an outer surface of the first sheet 310 when folded over. To prevent accidental attachment of the flap portion 340 to the front sheet, a strip of material may be removeably attached to the adhesive layer for removal before sealing the pouch 300. A double-sided tape with a peel-off paper on the outer surface, also known as a finger-lift tape, is an example of a means for adhesion of the flap portion to the front sheet. As will be appreciated, when formed from planar sheets of material, the pouch 300 is substantially flat which aids packing of a plurality of pouches in a compact manner.

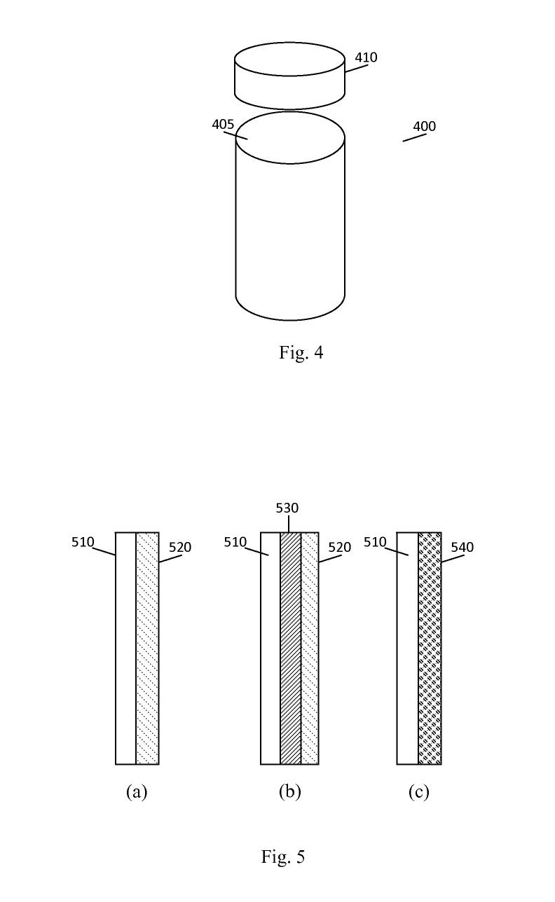

FIG. 4 illustrates a container 400 according to a further embodiment of the invention. The container of this embodiment is a bottle 400 having an open end 405 for receiving the nozzle 140 of the pump 100. In some embodiments, a lid 410 is provided to form a sealed enclosure with the bottle 410. The bottle 400 may be formed by, for example, an injection moulding process. The lid 410 may fasten to the bottle by means of a press or screw fit, as will be appreciated. Alternatively, the lid 410 may be moveable affixed to the bottle 400 by means of a hinge such that the lid 410 is moveable between an open position and a closed position.

The container 300, 400 of either the first or second embodiment may be formed of a material suitable to form a substantially impermeable enclosure, such that a liquid placed within the enclosure i.e. the medication 120 does not leak or permeate through the walls of the container 300, 400. The container 300, 400 may be made from relatively rigid or flexible material. Rigid materials may include metals such as aluminium or steel, glass, or plastics such as polyethylene, polypropylene, polycarbonate, cyclic olefin polymers/copolymers, polyvinyl chloride and polymethylmethacrylate. Flexible materials may include plastics such as cellophane, polyolefins, including polyethylene, polymethylpentene and polypropylene, polyvinyl chloride, polyethylene terephthalate (PET), and fluoropolymers, although other materials may be envisaged. A preferred material for a flexible container is polyethylene terephthalate. Furthermore, the container 300, 400 may be made from a flexible metal foil, such as aluminium foil, alone or laminated to or coated with one or more flexible plastic materials and/or paper.

In order to capture particularly the drug substance of the liquid medication 120, one or more interior surfaces of the container 300, 400 are associated with activated carbon cloth. Preferably, the one or more surfaces are major interior surfaces of the container 300, 400, such as interior surfaces of the first and/or second sheets 310, 320 of the pouch 300 or walls of the bottle 400.

Activated carbon (or activated charcoal) is a highly porous form of carbon with a very high surface area available for adsorption of a range of different molecules. It is produced in several forms including powders and granules. It is also possible to make fabrics of activated carbon (“activated carbon cloth”). Such activated carbon cloth may be a cloth formed from activated carbon (“pure activated carbon cloth”) or may be a fabric which is impregnated with activated carbon, such as in the form of fibres, strands, granules or powder. In the latter scenario, the fabric may also contain components to provide other properties such as liquid absorbency.

The activated carbon is associated with the one or more walls of the container 300, 400 by affixing, impregnating or otherwise attaching an activated carbon cloth to the one or more walls. By associating one or more interior surfaces of the container 300, 400 with the activated carbon cloth, when the container 300, 400 is inverted during use i.e. it is held with its open end facing downward to allow upright insertion of the spray 100 into the container 300, 400, the activated carbon cloth is retained therein. Furthermore, the properties of the activated carbon cloth, such as surface density, adsorptive surface area and, in some embodiments the form of pure activated carbon cloth, may be selected appropriately for adsorbing drugs intended to be disposed in the container.

The activated carbon cloth may be affixed, either directly or indirectly, as will be explained, to the interior surface(s) of the container 300, 400. The activated carbon cloth may be affixed to the one or more interior surfaces of the container 300, 400 by an adhesive. The adhesive may be applied, for example, by spray, to the interior surface(s) of the container 300, 400 and the activated carbon cloth brought into contact with the adhesive whilst still wet so as to bond the activated carbon cloth to the surface(s).

The inner surface(s) of the container 300, 400 may be pure activated carbon cloth or a fabric including activated carbon, as described above. Preferably pure activated carbon in the form of carbon cloth is associated with the one or more interior surfaces of the container 300, 400. Pure activated carbon cloth may be obtained from a number of suppliers including Chemviron Carbon (Zorflex (®)), Taiwan Carbon Technology Company (KOTHmex (R®)), MAST Carbon International (C-Tex) and Freudenberg.

The adsorptive properties of pure activated carbon cloth can be expressed in terms of parameters such as surface area and surface density of the material.

The pure activated carbon cloth for use in embodiments of the invention preferably has a surface density of at least 50 g/m², more preferably at least 70 g/m², and most preferably at least 100 g/m². Embodiments of the invention may also utilise pure activated carbon cloth having an adsorptive surface area of at least 500 m²/g, more preferably at least 700 g/m², and most preferably at least 900 g/m².

Pure activated carbon cloth is typically available in non-woven, woven or knitted forms. It has been found that the knitted form is preferable for use in embodiments of the invention since it has higher strength and reduced shedding of fibres and dust compared to other forms, such attributes aiding the fabrication into a container.

In some embodiments, one or more interior surfaces of the container 300, 400 contain one or more other absorbent materials for absorbing liquids, especially water. Absorbent materials include natural materials such as cellulose fibres (e.g. “fluff pulp”) and cotton fibres, and synthetic materials such as rayon and superabsorbent polymers such as cross-linked polyacrylic acids. A preferred absorbent material is airlaid cellulose, in which cellulose fibres are bonded together to form a textile-like material. The airlaid cellulose for use in embodiments of the invention may optionally contain a superabsorbent polymer, such as sodium polyacrylate, to provide additional capacity to absorb liquids. The absorbent material may be directly bonded to the interior surface of the container 300, 400 using an adhesive.

FIG. 5 illustrates various arrangements of materials within the container 300, 400. A first arrangement is shown in FIG. 5(a) whereby 510 is a wall of the container 300, 400 and the activated carbon cloth 520 is affixed to an interior surface of the wall 510. For example, the activated carbon cloth 520 may be attached to the interior surface of the wall 510 such as by means of an adhesive. A second arrangement is shown in FIG. 5(b) where an absorbent material 530 is affixed to the interior surface of the wall 510 and the activated carbon cloth 520 is affixed to an inwardly facing surface of the absorbent material 530. For example, the absorbent material 530 may be a sheet of synthetic material having a sheet of activated carbon cloth 520 bonded to the inner surface of the synthetic material. FIG. 5(c) shows a third arrangement whereby the activated carbon and absorbent materials are mixed into a single layer 540 which is affixed to the interior surface of the wall 510. The layer 540 may be activated carbon which is woven or otherwise incorporated into the absorbent material. It will also be realised that whilst not specifically illustrated one or more of the inner surfaces of the container 300, 400 may be associated with the activated carbon cloth, whilst one or more other, different, interior surfaces are associated with the absorbent material.

Adhesives suitable for bonding the layers of materials include those which are active at room temperature and atmospheric pressure and those which are activated by the application of heat and/or pressure and/or the uptake of moisture.

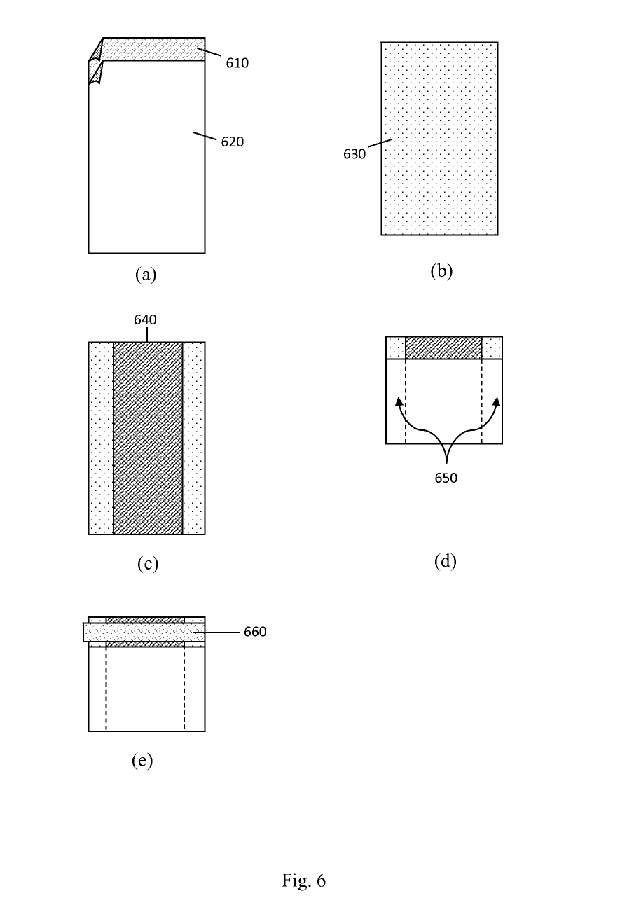

An example method of constructing an embodiment of the invention will now be explained with reference to FIG. 6.

Firstly, as shown in FIG. 6(a) a layer of polyethylene terephthalate (PET) 610 is bonded, using a moisture-curing polyurethane adhesive, to one face of a strip of absorbent material 620 comprising an airlaid cellulose containing sodium polyacrylate and polyester/polyethylene bicomponent fibre (binding agent). This forms a PET/absorbent laminate. The width of the laminate is approximately 50 mm, although it will be realised that other widths are envisaged.

As shown in FIG. 6(b), to the other, opposing, face of the absorbent material 620 a heat-sealing emulsion coating 630 (styrene acrylic copolymer) is applied and allowed to dry.

A strip of knitted pure activated carbon cloth 640 with a width of slightly less than the PET, i.e. approximately 40 mm, is placed centrally onto the absorbent face of the PET/absorbent laminate 61, 620 such that an approximately 5 mm wide section of absorbent material 620 is left exposed to either side of the activated carbon cloth 640 as shown in FIG. 6(c). Heat 650 is applied to the activated carbon cloth 640 in order to activate the styrene acrylic copolymer adhesive 630 and thereby bond the activated carbon cloth 640 to the absorbent layer 620.

The resulting strip of PET/absorbent/activated carbon cloth laminate 610, 620, 640 is subsequently cut into desired lengths to form a container of approximately half of the length. For example, the laminate may be cut into lengths of approximately 60 mm. A fold is made approximately 45 mm from the end of each cut piece of material with the PET 610 facing outwards and the activated carbon cloth 640 facing inwards. Heat is applied to the edges of material 610, where no activated carbon cloth 640 is present; the heat activates the styrene acrylic copolymer adhesive 630 and bonds the edges to form a pouch as shown in FIG. 6(d).

A strip of finger-lift tape 660 is applied to a flap formed at a top of the pouch, under which is a layer of adhesive to allow the flap to be sealed to the pouch body on removal of the tape, as shown in FIG. 6(e).

It is envisaged that a preferred means for disposal of the container according to embodiments of the invention is in waste disposal i.e. domestic waste disposal. Embodiments of the invention may be envisaged which are suitable for disposal in a fluid flowing conduit, such as a drain. In other words, embodiments of the invention may be envisaged which are suitable for disposal by flushing down a toilet.

An embodiment of the invention relates to a container, for example a flexible pouch as described with reference to FIGS. 5 and 6, with enhanced flushability. As embodiments of the present invention are suitable for use with liquid medicines, it may be assumed that a water-tight container should be utilised i.e. formed by the PET layer 610 shown in FIG. 6. However, problems have been noted with the efficient disposal of such water-tight containers down liquid flowing conduits, such as drains, wherein the container may float and be resistant to being readily carried away with the liquid flow, for example down the toilet. In these situations, the container may require a number of flushes to be expelled from the bowl of a toilet. It has been surprisingly found that this problem may be overcome by causing embodiments of the invention to be susceptible to liquid ingress i.e. by allowing water to penetrate into the container and to allow escape of air, for example entrapped within the absorbent material. In this way, the ease and speed of flushing can be enhanced by increasing the rate of water uptake into the container.

In some embodiments of the invention, liquid ingress is achieved by using a lower density of absorbent layer, which is less prone to entrap air, and/or by adding features to facilitate liquid entry into the container. In this way an outer wall of the container is formed to be at least partly liquid permeable.

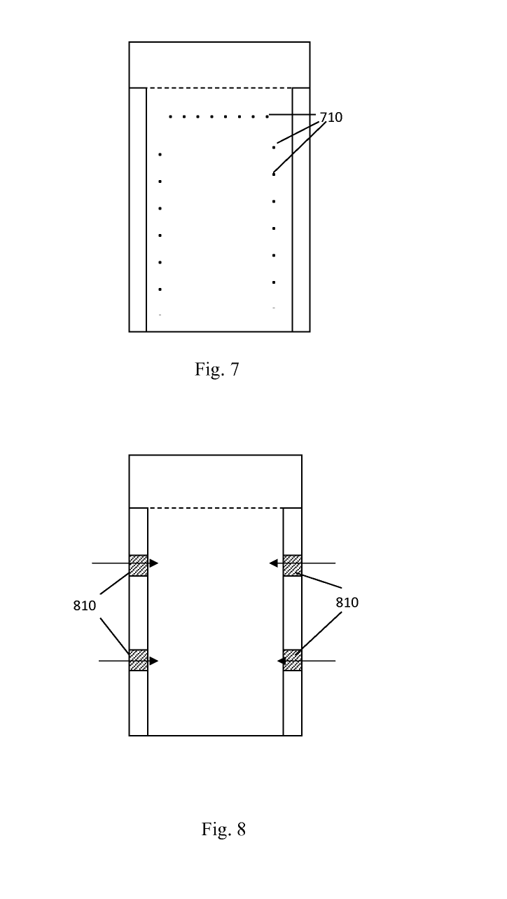

Referring to FIG. 7, one such feature which permits liquid ingress is the inclusion of one or more holes 710 or other perforations into an outer wall of the container. Such perforations 710 may be uniformly distributed across the surface of the container wall or, preferably, located in specific areas, for example adjacent to the seams or flap in the case of a pouch, such shown in FIG. 7. These latter locations minimise a possibility of liquid held within the absorbent layer of the container coming into contact with the fingers of any individual handling the container. Alternatively, or in addition, one or more apertures 810 may be included in a seam of a pouch to permit or enhance the rate of liquid uptake into the pouch, such as illustrated in FIG. 8. The apertures 910 permit liquid flow into the pouch via the seams.

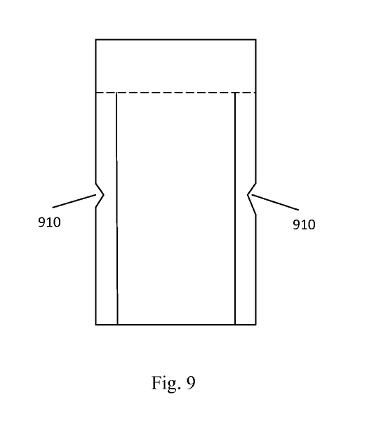

Enhanced flushability may also be achieved by including features which permit the container to be conveniently broken i.e. torn into two or more pieces, such as by adding one or more notches 910 into one or more of the seams of the pouch, such as illustrated in FIG. 9. Optionally a series of perforations may be provided adjacent to said notches 910 in order to aid tearing of the pouch across its width.

To determine whether a particular drug compound is suitable for disposal using this invention, its adsorption to activated carbon in water or any other suitable vehicle may be measured using the following procedure:

i) A solution of the drug compound is prepared, preferably in water or another aqueous medium. A sample of the solution is analysed for drug content using a suitable technique, such as high performance liquid chromatography (HPLC).
ii) The drug solution is added to activated carbon cloth.
iii) The drug solution and activated carbon cloth are mixed together in a vial, preferably with gentle mixing or agitation.
iv) After a suitable period of time, for example 10 minutes, a sample of solution is removed from the vial and analysed for drug content. If there has been a significant reduction in drug content, this will signify that the drug has adsorbed to the activated carbon cloth and will be suitable for use with this invention.

This invention is suitable for use with any drug which adsorbs to and is retained by activated carbon cloth. Drugs which are especially preferred for use with this invention are opioid analgesics, including fentanyl, sufentanil, alfentanil, morphine, diamorphine, etorphine, codeine, oxycodone, oxymorphone, hydromorphone, hydrocodone, buprenorphine, pethidine, butorphanol, levorphanol and methadone.

In use, the user, such as the patient intending to administer the medication 120 inserts the nozzle 140 of the spray 100 into the opening of the container 300, 400. The user then actuates the pump 130, for example by applying a force between the bottle 110 and the pump 130, such that a spray of liquid is emitted from the nozzle into the container 300, 400. The activated carbon cloth associated with the one or more interior surfaces of the container 300, 400 captures at least some of the one or more drugs present in the liquid, thereby aiding safe disposal of the medicine. In some embodiments, the liquid in which the drug is dissolved is also at least partially absorbed by the absorbent material present within the container 300, 400. Furthermore, in some embodiments, the container 300, 400 may also be sealed to physically contain the medicine for safe disposal. Advantageously, embodiments of the invention allow the capture and safe containment of medicines, particularly dispensed in the form of a spray.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A container for liquid medicine disposal, characterised by the container having one or more interior surfaces associated with an activated carbon cloth for capturing a drug dissolved in the liquid medicine and an absorbent material for absorbing a liquid component of the medicine.

2. The container of claim 1, wherein the activated carbon cloth is affixed to the one or more interior surfaces of the container.

3. The container of claim 1, wherein the absorbent material is associated with at least some of the interior surfaces associated with the activated carbon cloth

4. The container of claim 3, wherein the absorbent material is affixed to the one or more interior surfaces of the container and the activated carbon cloth is affixed to the absorbent material.

5. The container of claim 3, wherein the activated carbon cloth is affixed to the one or more interior surfaces of the container and the absorbent material is affixed to the activated carbon cloth.

6. The container of claim 3, wherein the activated carbon cloth is arranged within the absorbent material.

7. The container of claim 1, wherein the activated carbon cloth is substantially pure activated carbon cloth having a surface density of at least 50 g/m².

8. The container of claim 1, wherein the activated carbon cloth is substantially pure activated carbon cloth having an adsorptive surface area of at least 500 m²/g.

9. The container of claim 1, wherein the activated carbon cloth is substantially pure activated carbon knitted cloth.

10. The container of claim 1, comprising one or more liquid ingress means for permitting liquid ingress into the container.

11. The container of claim 10, wherein the liquid ingress means comprise one or more apertures.

12. The container of claim 11, wherein the one or more apertures are formed in a wall of the container.

13. The container of claim 11, wherein the one or more apertures are formed in a seam of the container.

14. The container of claim 1, comprising one or more regions arranged to allow a user to split the container.

15. The container of claim 14, wherein the regions comprise notches formed in a seam of the container.

16. The container of claim 1, wherein the absorbent material comprises airlaid cellulose.

17. The container of claim 16, wherein the absorbent material comprises a superabsorbent polymer.

18. The container of claim 1, wherein the container is a pouch or a bottle.

19. The container of claim 1 formed of a substantially impermeable material.

20. A method of making a container for disposing of liquid medicine, characterised by comprising:
associating an activated carbon cloth with one or more interior surfaces of a container for capturing a drug within the liquid medicine.

21. The method of claim 20, comprising arranging an absorbent material within the container for absorbing a liquid component of the medicine.

22. The method of claim 20, wherein the activated carbon cloth and the absorbent material are associated with one or more interior surfaces of the container.

23. The method of claim 22, wherein the absorbent material is associated with at least some of the interior surfaces associated with the activated carbon cloth.

24. The method of claim 23, comprising affixing the absorbent material to the one or more interior surfaces of the container and affixing the activated carbon cloth to the absorbent material.

25. The method of claim 23, comprising affixing the activated carbon cloth to the one or more interior surfaces of the container and affixing the absorbent material to the activated carbon cloth.

26. The method of claim 23, wherein the activated carbon cloth is co-formed with the absorbent material.

27. The method of claim 20, wherein the activated carbon cloth is substantially pure activated carbon cloth having a surface density of at least 50 g/m².

28. The method of claim 20, wherein the activated carbon cloth is substantially pure activated carbon cloth having an adsorptive surface area of at least 500 m²/g.

29. The method of claim 20, wherein the activated carbon cloth is substantially pure activated carbon knitted cloth.

30. The method of claim 20, comprising forming one or more liquid ingress means for permitting liquid ingress into the container.

31. The method of claim 30, wherein the liquid ingress means comprise one or more apertures.

32. The method of claim 31, wherein the one or more apertures are formed in a wall of the container.

33. The method of claim 31, wherein the one or more apertures are formed in a seam of the container.

34. The method of claim 20, comprising forming one or more regions for allowing a user to split the container.

35. The method of claim 34, wherein the regions comprise notches formed in a seam of the container.
